(19) United States
(12) Patent Application Publication
(10) Pub. No.: US 2001/0028796 A1
(43) Pub. Date: Oct. 11, 2001

(54) Image taking apparatus, image taking method and camera

(76) Inventors: Mutsuhiro Yamanaka, Osaka (JP); Hironori Sumitomo, Osaka (JP); Yasuhisa Kinto, Osaka (JP)

Correspondence Address: SIDLEY AUSTIN BROWN & WOOD, 717 NORTH HARWOOD, SUITE 3400, DALLAS, TX, 75201, US

(21) Appl. No.: 09/825,400

(22) Filed: Apr. 3, 2001

(30) Foreign Application Priority Data
Apr. 6, 2000 (JP) 2000-105267
Apr. 6, 2000 (JP) 2000-105270

(51) Int. Cl. G03B 17/18; H04N 5/225

(52) U.S. Cl. 396/281; 348/218

(57) ABSTRACT

An image taking apparatus has a multiplex image taking mode for taking a plurality of images to be subjected to multiplex image processing by which a plurality of images are composed into a single image. The image taking apparatus includes a detector which detects abnormality disturbing the multiplex image processing when the images are being taken in the multiplex image taking mode and a controller which suspends processing in the multiplex image taking mode when the abnormality is detected by the detector.

This application claims priority to Japanese Patent Applications Nos. 2000-105267 and 2000-105270 each filed on Apr. 6, 2000, the disclosure of which is incorporated by reference in its entirety.

### BACKGROUND OF THE INVENTION

1. Field of the Invention

The present invention relates to an image taking apparatus, an image taking method and a camera, which can be applied to a digital camera and the like.

2. Description of Related Art

Conventionally, for example, a digital camera, which can take an image in a mode called a multiplex image taking mode for a multiplex image processing, is known.

Such a multiplex image processing is a processing for composing a plurality of images of the same photographic object taken in different photographic conditions into a single image. The multiplex image processing includes, for example, high-resolution processing for creating a high-resolution image from a plurality of images, depth control processing for adjusting depth of field by composing a plurality of images, large tone processing for extending a dynamic range for taking an image and image stabilize processing for creating an image with no blur caused by camera movement by composing a plurality of images. The multiplex image processing is carried out by a digital camera or an external personal computer and the like. The aforementioned multiplex image taking mode is a mode for obtaining a plurality of images subjected to the aforementioned multiplex image processing.

In the aforementioned multiplex image taking mode, it is a premise to take a plurality of images of the same photographic object from nearly the same image taking position. Therefore, in the multiplex image taking mode, a plurality of images of the aforementioned same photographic object are taken in sequence. Specifically, a plurality of images are sequentially taken upon a single image taking instruction by a user.

By the way, a user sometimes takes an image of a photographic object without checking the current mode. For example, in a state that the present mode is set to a multiplex image taking mode, if a user sends an image taking instruction to the digital camera, misunderstanding that the current mode is set to a single image taking mode, the user may move the digital camera when images are being taken. However, if the digital camera is moved when multiplex images are being taken, images taken at different image taking positions greatly shifted each other will be subjected to multiplex image processing. As a result, a good final composite image cannot be obtained. Furthermore, if an obstacle suddenly appears in front of the digital camera when a plurality of images are being taken, some of the images including the image of the obstacle will also be subjected to multiplex image processing. As a result, a good final composite image cannot be obtained. The possibility of making the aforementioned mistake becomes high especially when the same image taking instruction member is shared in both the single image taking mode and the multiplex image taking mode.

Furthermore, at the stage of the multiplex image processing after having taken the multiplex images, when some images among a plurality of images taken are under-exposure, blackish portions in which shadow gradation is lost may occur in a composite image. On the contrary, when unexpectedly strong light is irradiated to the photographic object, whitish portions in which highlight gradation is lost may occur in a composite image. When an image including such blackish portions or whitish portions is subjected to multiplex image processing, the quality of the final composite image deteriorates in appearance. Thus, such an image including blackish portions or whitish portions is inappropriate for multiplex image processing.

### SUMMARY OF THE INVENTION

It is an object of the present invention to provide an image taking apparatus which can prevent a generation of an unsuitable final composite image when abnormality disturbing multiplex image processing arises in a multiplex image taking mode.

It is another object of the present invention to provide an image taking method which can prevent a generation of an unsuitable final composite image when abnormality disturbing multiplex image processing arises in a multiplex image taking mode.

It is still another object of the present invention to provide an image taking apparatus which can notify a user that abnormality disturbing multiplex image processing arises when the abnormality arises in a multiplex image taking mode.

It is still yet another object of the present invention to provide an image taking apparatus which can prevent an unfavorable movement of the image taking apparatus when images are being taken in a multiplex image taking mode.

It is still yet another object of the present invention to provide a camera which can prevent a generation of an unsuitable final composite image when abnormality disturbing multiplex image processing arises in a multiplex image taking mode.

It is still yet another object of the present invention to provide a camera which can notify a user that abnormality disturbing multiplex image processing arises when the abnormality arises in a multiplex image taking mode.

It is still yet another object of the present invention to provide a camera which can notify a user that images are being taken in a multiplex image taking mode.

According to a first aspect of the present invention, an image taking apparatus has a multiplex image taking mode for taking a plurality of images to be subjected to multiplex image processing by which a plurality of images are composed into a single image. The image taking apparatus includes a detector which detects abnormality disturbing the multiplex image processing when the plurality of images are being taken in the multiplex image taking mode, and a controller which suspends processing in the multiplex image taking mode when the abnormality is detected by the detector.

With this image taking apparatus, when abnormality is detected when images are being taken, e.g., when the apparatus moves slightly or exposure becomes inappropriate when images are being taken, when an obstacle crossed in front of the image taking lens, or when the power source went dead, processing in the multiplex image taking mode is suspended. As a result, a poor image corresponding to the abnormality is prevented from being automatically subjected to the multiplex image processing. This prevents a generation of inappropriate final composite image.

According to a second aspect of the present invention, an image taking apparatus has a multiplex image taking mode for taking a plurality of images to be subjected to multiplex image processing by which a plurality of images are composed into a single image. The image taking apparatus includes a detector which detects whether or not abnormality disturbing the multiplex image processing resides in images taken in the multiplex image taking mode and a controller which suspends processing in the multiplex image taking mode when the abnormality is detected by the detector.

With this image taking apparatus, when there is an image including abnormality, e.g., an image including blackish portions or whitish portions in which shadow gradation or highlight gradation is lost, the processing in the multiplex image taking mode is suspended. As a result, the image including such blackish portions or whitish portions is prevented from being automatically subjected to the multiplex image processing. This prevents a generation of inappropriate final composite image.

According to a third aspect of the present invention, an image taking apparatus has a multiplex image taking mode for taking a plurality of images to be subjected to multiplex image processing by which a plurality of images are composed into a single image. The image taking apparatus includes a detector which detects abnormality disturbing the multiplex image processing when images are being taken in the multiplex image taking mode and a display which indicates that a multiplex image taking is unsuccessful when the abnormality is detected by the detector.

With this image taking apparatus, a user can recognize by the display that the multiplex image taking is unsuccessful.

According to the fourth aspect of the present invention, an image taking apparatus has a multiplex image taking mode for taking a plurality of images to be subjected to multiplex image processing by which a plurality of images are composed into a single image. The image taking apparatus includes a detector which detects whether or not abnormality disturbing the multiplex image processing resides in the images taken in the multiplex image taking mode and a display which indicates that a multiplex image taking is unsuccessful when the abnormality is detected by the detector.

With this image taking apparatus, a user can recognize by the display that abnormality arose.

According to the fifth aspect of the present invention, an image taking method comprises: detecting abnormality disturbing multiplex image processing when multiplex images are being taken, wherein the multiplex images are subjected to the multiplex image processing to be composed into a single image; and suspending processing in the multiplex image taking mode when the abnormality is detected.

With this image taking method, when abnormality is detected when images are being taken, the processing in the multiplex image processing mode is suspended. As a result, the inappropriate image corresponding to the abnormality is prevented from being automatically subjected to the multiplex image processing. This prevents a generation of inappropriate final composite image.

According to the sixth aspect of the present invention, an image taking method comprises: detecting abnormality residing in a plurality of images taken by a multiplex image taking, wherein the abnormality disturbs multiplex image processing of the plurality of images by which the plurality of images are composed into a single image; and suspending processing in the multiplex image taking mode when the abnormality is detected.

With this image taking method, when abnormality is detected in the obtained image, the processing in the multiplex image taking mode is suspended. As a result, an inappropriate image corresponding to the abnormality is prevented from being automatically subjected to the multiplex image processing. This prevents a generation of inappropriate final composite image.

According to the seventh aspect of the present invention, an image taking apparatus has a multiplex image taking mode for taking a plurality of images to be subjected to multiplex image processing by which a plurality of images are composed into a single image. The image taking apparatus includes a display which indicates that images are being taken in the multiplex image taking mode.

With this image taking apparatus, since the display indicates that images are being taken in the multiplex image taking mode, a user can correctly recognize that the current image taking mode is a multiplex image taking mode through the aforementioned display. Accordingly, it is possible to prevent that an user moves the image taking apparatus when images are being taken, misidentifying a current multiplex image taking mode as a single image taking mode.

According to the eighth aspect of the present invention, a camera includes a selector which selects a first mode for taking a single image or a second mode for taking a plurality of images to be composed into a single image and a display which indicates the first mode or the second mode.

With this camera, a user can recognize the current image taking mode, i.e., the first mode or the second mode.

According to the ninth aspect of the present invention, a camera includes a selector which selects a specific mode for taking a plurality of images to be composed into a single image among a plurality of image taking modes, a detector for detecting whether or not there is abnormality disturbing the composing when the plurality of images are being taken in the specific mode, and a controller which suspends processing in the specific mode when the abnormality is detected by the detector.

With this camera, when abnormality is detected when images are being taken, the processing in the multiplex image taking mode is suspended. As a result, it is prevented an inappropriate final composite image from being generated by automatically continuing the processing in the multiplex image taking mode.

According to the tenth aspect of the present invention, a camera includes a selector which selects a specific mode for taking a plurality of images to be composed into a single image among a plurality of image taking modes, a detector which detects whether or not abnormality disturbing the composing resides in the plurality of images taken in the specific mode, and a controller which suspends processing in the specific mode when the abnormality is detected by the detector.

With this camera, when there is an abnormal image, the processing in the multiplex image taking mode is suspended. Thus, it is prevented an inappropriate final composite image from being generated.

According to the eleventh aspect of the present invention, a camera includes a selector which selects a specific mode for taking a plurality of image to be composed into a single image among a plurality of image taking modes, a detector for detecting whether or not there is abnormality disturbing the composing when the plurality of images are being taken in the specific mode and a display which indicates that the image taking in the specific mode is unsuccessful when the abnormality is detected by the detector.

With this camera, a user can recognize by the display that the multiplex image taking is unsuccessful.

According to the twelfth aspect of the present invention, a camera includes a selector which selects a specific mode for taking a plurality of images to be composed into a single image among a plurality of image taking modes, a detector which detects whether or not abnormality disturbing the composing resides in the plurality of images taken in the specific mode, and a display which indicates that the image taking in the specific mode is unsuccessful when the abnormality is detected by the detector.

With this camera, a user can recognize by the display that abnormality arose.

Other objects and the features will be apparent from the following detailed description of the invention with reference to the attached drawings.

### BRIEF DESCRIPTION OF THE DRAWINGS

The present invention will be more fully described and better understood from the following description, taken with the appended drawings, in which:

FIG. 1 is a front view showing a digital camera which is an embodiment of the present invention is applied;

FIG. 2 is a rear view showing the digital camera;

FIG. 3 is a bottom view showing the digital camera;

FIG. 4 is a block diagram showing a control system of the digital camera;

FIG. 5 is a block diagram showing the whole control system shown in FIG. 4;

FIG. 6 is an explanatory view of an image memory structure in a memory card;

FIG. 7 is an explanatory view of a display portion provided in a liquid crystal display portion (view finder);

FIG. 8 is a flow chart showing an operation in a single image taking mode;

FIG. 9 is a flow chart showing an operation in a multiplex image taking mode;

FIG. 10 is an explanatory view of a selection method of a plurality of images;

FIG. 11 is an explanatory view of a modification of the display portion in a finder;

FIG. 12 is an explanatory view of another modification of the display portion in the finder;

FIG. 13 is a front view of the digital camera showing the display portion when multiplex images are being taken; and

FIG. 14 is a flow chart showing an operation in a multiplex image taking mode in another embodiment.

### DETAILED DESCRIPTION OF THE PREFERRED EMBODIMENTS

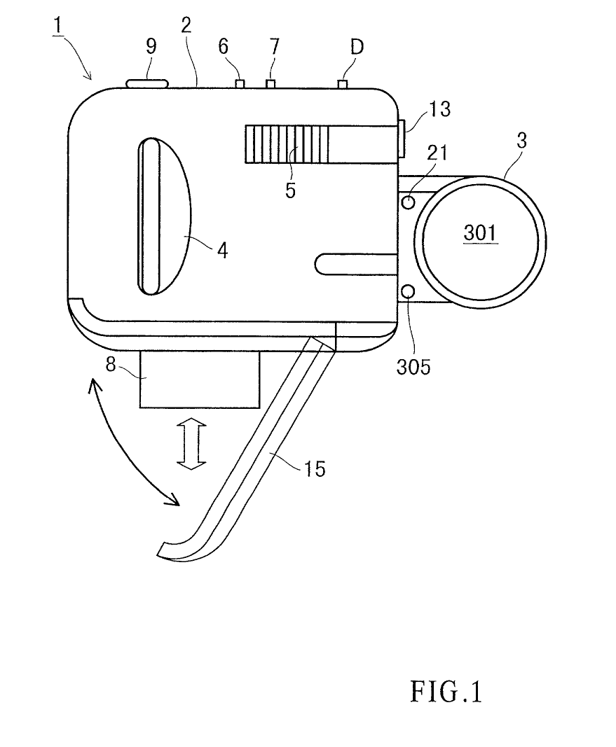

FIGS. 1 to 3 show a digital camera as an image taking apparatus according to an embodiment of the present invention. In this embodiment, multiplex image processing is executed by an external apparatus such as a personal computer.

As shown in FIGS. 1 to 3, the digital camera 1 comprises a box-shaped camera main body 2 and a rectangular parallelepiped image pick-up portion 3 which is attachable to and removable from the main body 2 on the right side thereof in the front view shown in FIG. 1. The image pick-up portion 3 is pivotable within a plane parallel to the right side of the main body 2.

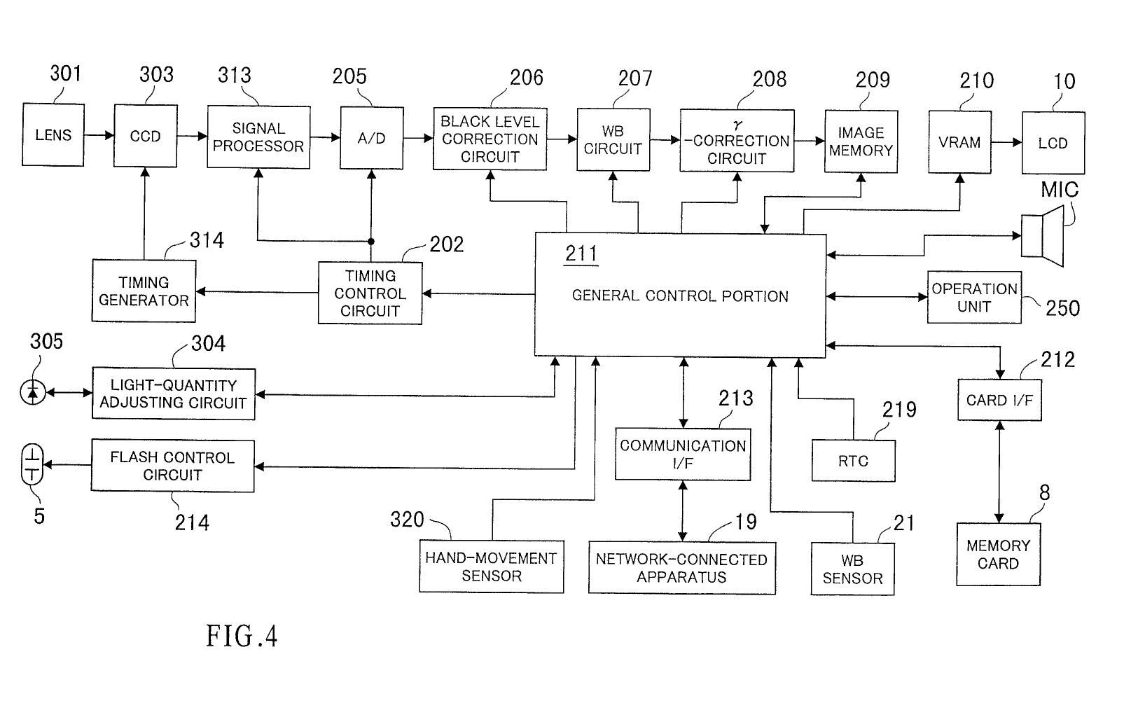

The image pick-up portion 3 has an image taking apparatus including an image taking lens 301 comprising a zoom lens and a photoelectric conversion device such as a CCD 303 (Charge Coupled Device) shown in FIG. 4, to convert the optical image of a photographic object into an electric image consisting of charge signals, each of which was generated by each pixel of the CCD via photoelectric conversion.

The camera main body 2 has a display 10 or an LCD (Liquid Crystal Display), a slot 17 for receiving a memory card 8 as a recording media and a connection terminal 13 for connecting the digital camera 1 to a personal computer or the like. The image signal taken by the image pick-up portion 3 is subjected to prescribed signal processing. The processed image is displayed on the LCD 10, recorded in the memory card 8 or transferred to network connected apparatus 19 (see FIG. 4) such as a personal computer.

The image taking lens 301 is provided in the image pick-up portion 3. An image pick-up circuit including a CCD color area sensor 303 (FIG. 4) is provided at an appropriate position behind the image taking lens 301. A light-quantity adjusting circuit 304 having a light receiving sensor 305 for receiving flash light reflected from the photographic object is provided at an appropriate position in the image pick-up portion 3.

The light receiving sensor 305 detects an amount of incident ray into the image taking lens 301, and also can detect that a person, etc. crossed in front of the image taking lens 301.

Furthermore, a white balance (WB) sensor 21, a distance sensor (not shown), etc. are provided at a proper place in the image pick-up portion 3. The WB sensor 21 detects the color temperature of light to adjust the white balance of an image. Furthermore, the distance sensor measures the distance to a photographic object for an automatic focus (AF).

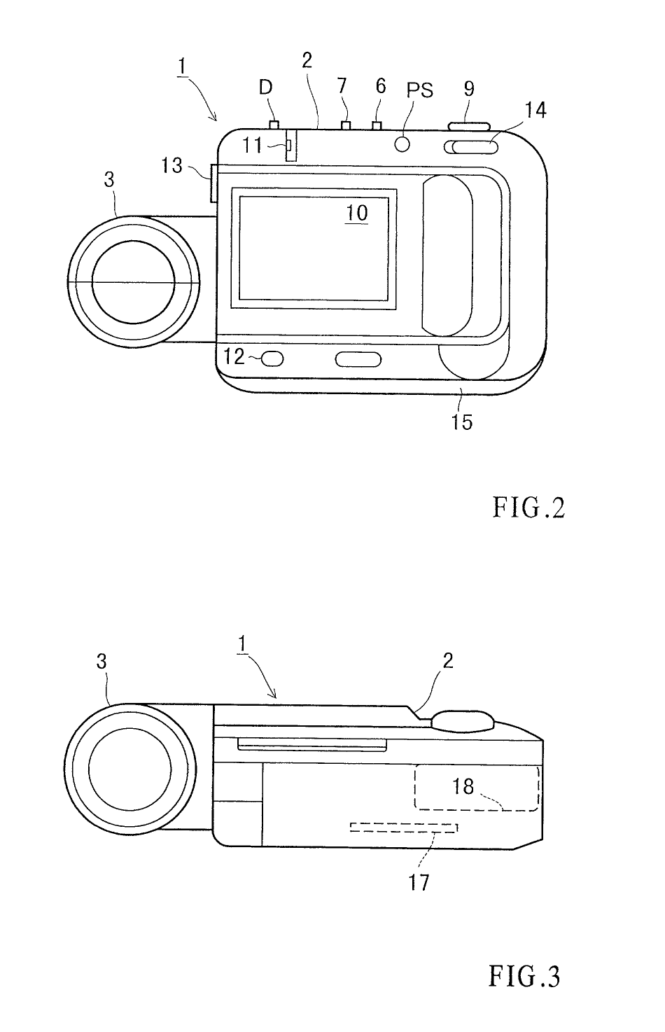

As shown in FIG. 1, a grip 4 is formed in the left-hand side of the front face of the camera main body 2, and a built-in electronic flash 5 is provided in the right-hand upper side at an appropriate position. Frame forwarding and reversing switches 6 and 7 are provided near the center of the top face of the camera main body 2 as shown in FIG. 1. The forwarding switch 6 changes the displayed frame in the direction that the frame number increases in the image taking order, and is referred to as an UP key 6. The reversing switch 7 changes the displayed frame in the direction that the frame number decreases, and is referred to as a DOWN key 7. A delete key D for deleting the images recorded in the memory card 8 is provided on the left side of the DOWN key 7, and a shutter button 9 is provided on the right side of the UP key 6 in the rear view shown in FIG. 2.

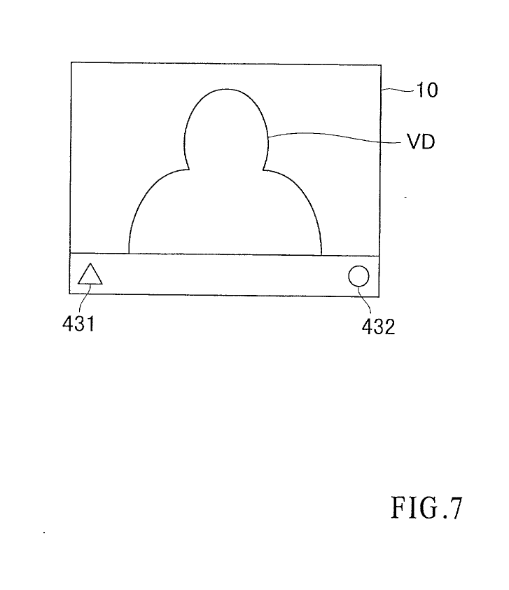

As shown in FIG. 2, an LCD 10 is provided in the middle of the left-hand side of the rear face of the camera main body 2. The LCD 10 functions as a viewfinder during image taking, and as a display during the reproduction of the recorded image. Furthermore, as shown in FIG. 7, at the lower portion in the LCD 10, an indicator 431 for indicating/warning a generation of abnormality inconvenient to multiplex image processing in the multiplex image taking mode and an indicator 432 for indicating that images are being taken in the multiplex image taking mode, are provided so that a user can easily recognize the aforementioned indicators 431 and 432 when the user views the image of the photographic object VD. The turn-on/off control of the indicator 432 is performed by the general control portion 211 based on the signal of the mode setting switch 14 which will be mentioned later. Also, the turn-on/off control of the indicator 431 is performed by the general control portion 211.

Provided at the lower side of the LCD 10 is a compression rate setting slide switch 12 for switching the compression rate K of the image data to be recorded in the memory card 8. A power switch PS is provided on the top portion of the rear face of the camera main body 2. The connection terminal 13 is provided on the side face of the camera main body 2 near the image pick-up portion 3.

Furthermore, the microphone combination speaker MIC for recording sound or generating the recorded sound at the time of reproduction is provided at the camera main body 2. When an image signal is reproduced, the voice signal included in the image signal can be heard through the microphone MIC.

The electronic flash (which may be abbreviated as “FL”) of the digital camera 1 has an “automatic flash mode,” a “forcible flash mode” and a “flash prohibition mode.” In the “automatic flash mode,” the built-in electronic flash 5 is automatically flashed according to the luminance of the photographic object. In the “forcible flash mode,” the built-in electronic flash 5 is forcibly flashed regardless of the luminance of the photographic object. In the “flash prohibition mode,” light emission of the built-in electronic flash 5 is prohibited. Every time the user depresses the FL mode setting key 11 positioned above the LCD 10 on the rear face of the camera main body 2, the flash mode is switched among three modes in a cyclic order.

The digital camera 1 has a 1/8 compression rate and a 1/20 compression rate, and a user can select the preferred compression rate K. For example, when the compression rate setting switch 12 is shifted to the right, the compression rate K is set to 1/8, and when it is shifted to the left, the compression rate K is set to 1/20.

Furthermore, at the right end upper portion of the rear surface of the camera main portion 2, a mode setting switch 14 for selecting one of a “standard image taking mode (single image taking mode)” and a “multiplex image taking mode” is provided. The aforementioned standard image taking mode is a mode for taking a single image, and the aforementioned multiplex image taking mode is a mode for sequentially taking a plurality of images for multiplex image processing. The mode setting switch 14 is also a slide switch of two positions. When the switch is shifted to the right, the standard image taking mode will be selected, and when it is shifted to the left, the multiplex image taking mode will be selected.

A battery cavity 18 and a slot 17 for receiving a memory card 8 are provided at the bottom face of the main body 2. The battery cavity 18 and the slot 17 are covered with a clam-shell type cover 15. The digital camera 1 according to this embodiment uses a power supply source consisting of four AA batteries connected in series.

FIG. 4 is a block diagram of the control system of the digital camera 1.

In the image pick-up portion 3, the CCD 303 photoelectrically converts the optical image of the photographic object focused by the zoom lens 301 into image signals of three color components R (red), G (green) and B (blue). The image signal consists of sequence of pixel signals received by the respective pixel. The timing generator 314 generates various kinds of timing pulses for controlling the drive of the CCD 303.

Since the size of an aperture stop of the image pick-up portion 3 is fixed, the exposure control is performed by adjusting the quantity of light exposure of the CCD 303, i.e., the electric charge accumulation time of the CCD 303 corresponding to the shutter speed. When the luminance of the photographic object is too low to select to an appropriate shutter speed, the level of the image signal outputted from the CCD 303 is adjusted in order to compensate for the insufficient exposure. In other words, at a low luminance, the exposure is controlled by adjusting both the shutter speed and the gain. The level of the image signal is adjusted by controlling the gain of the AGC circuit in the signal processor 313.

The timing generator 314 generates various driving control signals for the CCD 303 based on the reference clock supplied from the timing control circuit 202. The signals generated by the timing generator 314 includes a timing signal for starting and finishing integration (i.e., exposure), and clock signals for controlling the reading timing of the light-receiving signals (horizontal synchronization signals, vertical synchronization signals, transfer signals, etc.) from the respective pixels. These timing signals are supplied to the CCD 303.

The signal processing circuit 313 performs predetermined analog signal processing to the image signal (analog signal) outputted from the CCD 303. The signal processing circuit 313 has a CDS (correlation double sampling) circuit for reducing the noise of the image signal and an AGC (automatic gain control) circuit for adjusting the level of the image signal by controlling the gain of this AGC circuit.

The light-quantity adjusting circuit 304 sets the light emission of the built-in electronic flash 5 to a predetermined level determined by the general control portion 211 when the electronic flash is used during the image taking. During the flash image taking, the flash light reflected from the photographic object is received by the light-adjusting sensor 305 upon starting exposure. When the quantity of light received by the sensor 305 reaches a predetermined level, the light-quantity adjusting circuit 304 supplies a flash stop signal to the flash control circuit 214 via the general control portion 211. In response to the flash stop signal, the flash control circuit 214 stops the light emission of the built-in electronic flash 5, whereby the light emission amount of the built-in electronic flash 5 can be regulated to the prescribed level.

The light-receiving sensor 305 is also used as a light-receiving element for controlling the exposure, which measures a brightness of the photographic object in a sequence image taking mode. The light-receiving sensor 305 detects the difference of the brightness with regard to the brightness at the start of the sequence image taking mode to adjust the exposure of the next frame in the sequence mode in accordance with the difference.

The A/D converter 205 provided in the camera main body 2 converts each pixel signal (i.e., analog signal) of the image signal sequence into a 10-bit digital signal based on the A/D conversion clock supplied from the A/D clock generator (not shown).

A timing control circuit 202 which generates a reference clock and a clock for a timing generator 314 and an A/D convertor 205 is also provided in the camera main body 2. The timing control circuit 202 is controlled by the general control portion 211.

A black level correction circuit 206 corrects the black level of the digitalized pixel signal (hereinafter referred to as pixel data) converted by the A/D converter 205 to the reference black level. A white balance circuit (hereinafter 5 referred to as “WB circuit”) 207 converts the level of the pixel data of each color component of R, G or B, so that the white balance can be also adjusted after γ correction. The WB circuit 207 converts the level of the pixel data of each color component R, G, B using a level conversion table inputted from the general control portion 211. The conversion coefficient (or the slope of the characteristic line) for each color component in the level conversion table is set each taken image by the general control portion 211.

The γ correction circuit 208 corrects for the characteristic of the pixel data. The γ correction circuit 208 has, for example, six γ correction tables with different characteristics, and uses the most appropriate γ correction table according to the photographed scene or the photographic conditions.

An image memory 209 stores the pixel data outputted from the γ correction circuit 208. The memory capacity of the image memory 209 corresponds to M frames data. Accordingly, if the CCD 303 has an n×m pixel matrix, the image memory 209 has a memory capacity of M×n×m pixel data, and each pixel data is stored in the corresponding pixel position in the memory.

A VRAM 210 is a buffer memory for storing the image data which is to be reproduced and displayed on the LCD 10. The memory capacity of the VRAM 210 corresponds to the number of pixels of the LCD 10.

“MIC” denotes a microphone combination speaker, as mentioned above. In cases where the below-mentioned image signals are reproduced, the voice signals are separated from the image signals by the general control portion 211, and the separated voice signals can be heard through this speaker MIC.

In the image taking preparation mode, each pixel data of the image taken by the image pick-up portion 3 every 1/30 seconds is subjected to the prescribed signal processing by the sequence from the A/D converter 205 to the γ correction circuit 208, and stored in the image memory 209. This pixel data is simultaneously transferred to the VRAM 210 via the general control portion 211, and displayed on the LCD 10. Whereby, the user can recognize the photographic object on the LCD 10. In the reproduction mode, the image read out from the memory card 8 is subjected to the prescribed signal processing by the general control portion 211, which is then transferred to the VRAM 210, and displayed on the LCD 10.

A card I/F 212 is an interface for writing the image data into the memory card 8 or reading the image data from the memory card 8. A communication I/F 213 is an interface based on, for example, the IEEE 1394 standard, or an interface for externally connecting the personal computer 19.

A flash control circuit 214 controls light emission of the built-in electronic flash 5. In particular, the flash control circuit 214 controls the quantity of flash light, flash emission timing, and so on, based on the control signal supplied from the general control portion 211. The flash control circuit 214 also brings the light emission to zero based on the flash stop signal STP inputted from the light-quantity adjusting circuit 304.

An RTC (Real Time Clock) 219 is a time circuit for keeping the track of the date and time of each image taking, which is driven by a separate power source (not shown).

An operation unit 250 has switches corresponding to the UP key 6, the DOWN key 7, the shutter button 9, the FL mode setting key 11, the compression rate setting key 12, and the photographing/reproduction mode setting switch 14.

The aforementioned WB sensor 21 and a camera-movement sensor 320 are connected to the general control portion 211. The camera-movement sensor 320 detects the movement of the digital camera 1 when a user is taking an image while holding the camera, for example, by hands, and includes a gyroscope having a position displacement detection function. Moreover, a sensor (not shown) for detecting the capacity shortage of each power supply is also connected to the general control portion 211.

The general control portion 211 comprises a micro computer, and it organically controls the drive of each element in the image pick-up portion 3 and the camera main body 2 so as to generally control the image taking operation of the digital camera 1.

Furthermore, in a state where the mode setting switch 14 is set to the multiplex image taking mode, the general control portion 211 also functions as abnormality detector for detecting abnormalities caused during the image taking and/or inappropriate images from information obtained from the camera-movement detection sensor 320, the WB sensor 21, the luminescence-control sensor 305, a distance sensor (not shown) and/or a sensor for detecting a battery-run-out. The aforementioned abnormality includes camera-movements, obstacle-crossing, sudden changes of incidence light and a buttery-run-out, which are inappropriate conditions by which inappropriate images may be obtained by executing multiplex image processing. The aforementioned inappropriate images include an image which is inappropriate for the multiplex image processing. When abnormality is detected, the general control portion 211 also functions as control means for suspending the processing in the multiplex image taking mode and indicating that the multiplex image taking was unsuccessful.

Furthermore, the general control portion 211 has the image number counter which counts the number of images for a multiplex image taking.

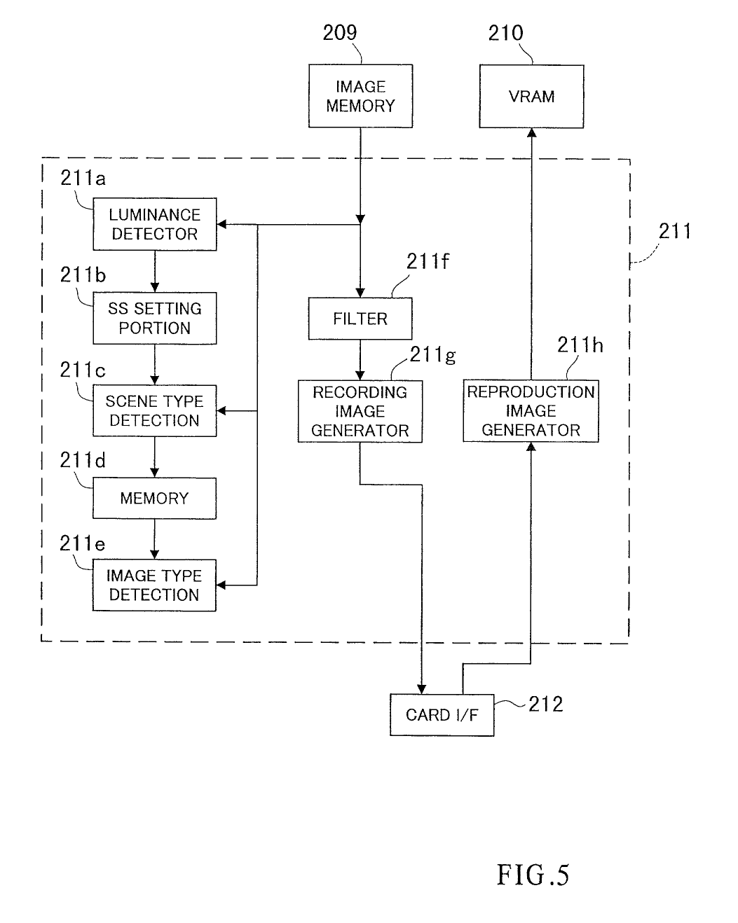

As shown in FIG. 5, the general control portion 211 has a luminance detector 211a for setting an exposure control value (i.e., a shutter speed) and a shutter speed setting unit 211b. In the image taking preparation mode, the luminance detector 211a detects the brightness of the photographic object based on the image taken by the CCD 303 every 1/30 seconds. In other words, the luminance detector 211a determines the brightness of the photographic object from the image data updated and stored in the image memory 209.

The luminance detector 211a divides the memory area of the image memory 209 into nine blocks, and calculates the luminance of each block based on the pixel data representing the G (green) component.

The shutter speed setting unit 211b has a shutter speed table, and determines the shutter speed (that is, the integral time of the CCD 303) based on the brightness of the photographic object detected by the luminance detector 211a.

The shutter speed is initialized to 1/128 seconds at the beginning of the activation of the digital camera 1. During the image taking preparation mode, the shutter speed setting unit 211b varies the shutter speed from the initial value to a higher speed or a lower speed stepwise, based on the brightness detected by the luminance detector 211a.

The general control portion 211 has a scene type detector 211c which determines the current image taking condition among from four types of scenes, “low-luminance scene,” “middle-luminance normal scene,” “middle-luminance backlight scene,” and “high-luminance scene,” in order to set the optimum shutter speed, and to appropriately perform the γ correction and filtering correction (which will be described in more detail below). In the “low-luminance scene,” auxiliary light (i.e., flash light) is generally required when taking an image, for example, in indoor or in the night fall. In the “middle-luminance normal scene,” the brightness of available light (either natural light or artificial light) is appropriate, and a picture is taken out of the light without auxiliary light. In the “middle-luminance backlight scene,” the brightness is appropriate, however, a picture is taken against light. In this case, flash light is desired. The “high-luminance scene” is on the very bright condition, such as a scene on the beach or a ski slope in a clear day. The determination result of the scene type detector 211c is stored in the memory 211d.

The general control portion 211 also has an image type detector 211e which determines whether the taken image is an ordinary photographic image (referred to as a “natural image”), such as a landscape or a portrait, or a text image, such as characters or charts written on a white board (referred to as a “text image” which resembles a binary image).

The image type detector 211e creates a histogram of the luminance of each pixel location based on the pixel data of the image stored in the image memory 209, and then, determines whether the photographed image is a natural image or a text image based on the histogram.

In general, the histogram of the luminance of the natural image has a gently curved luminance distribution with a single peak value, while the text image has a double-peak luminance distribution with two conspicuous areas in the black and white portions of the image, respectively. Therefore, the image type detector 211e distinguishes whether a picked-up image is natural image or character image by distinguishing whether the histogram of the luminosity data of a picked-up image is 1-peak distribution, or it is 2-peak distribution. And this judgment result is also stored in the memory 211d.

In order to record the taken image, the general control portion 211 has a filter 211f for filtering the image data, a recording image generator 211g for generating a thumbnail image and a compressed image and a reproduction image generator 211h for reproducing the image recorded in the memory card 8 on the LCD 10.

The filter 211f consists of five digital filters to correct for the high frequency component of the image data at each compression rate 1/8 or 1/20, thereby correcting the edge in the image to be recorded. Five filters includes a digital filter for performing a standard edge correction, two digital filters for enhancing the edge of the image in comparison with the standard edge correction, and two digital filters for weakening the edge of the image in comparison with edge correction.

The recording image generator 211g reads the pixel data out of the image memory 209, and generates a thumbnail image and a compressed image which are to be recorded in the memory card 8. To be more precise, the recording image generator 211g scans the image memory 209 in the raster direction, and reads out every 8 pixels in both the horizontal and vertical directions to create a thumbnail image. The read pixel data (or the thumbnail images) are successively transferred to and recorded in the memory card 8.

The recording image generator 211g also reads out the entire pixel data from the image memory 209, and applies a prescribed data compression based on a JPEG method, such as two-dimensional DCT conversion or Huffman coding, to create a compressed image data. The compressed image data is recorded in the primary image area of the memory card 8.

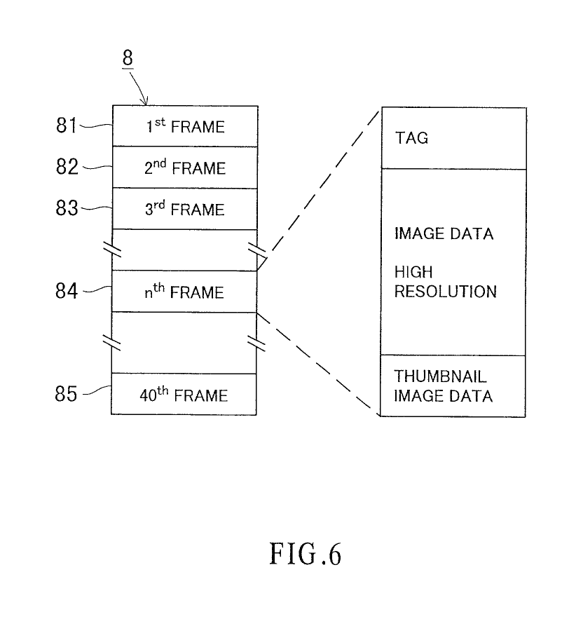

As shown in FIG. 6, the memory card 8 can store forty frames of images taken by the digital camera 1 at a 1/20 compression rate. Each of the frames 81-85 has tag information, high-resolution image data (640×480 pixels) compressed by a JPEG method, and thumbnail image data (80×60 pixels). Each frame may be an image file of EXIF type.

When in the image taking mode the shutter button 9 is depressed to start image taking, the general control portion 211 creates a thumbnail image created from the image taken in the image memory 209 after the start of the image taking operation, and the compressed image created by a JPEG method when the compression mode is selected by manipulating the compression rate setting slide switch 12. A tag information (such as the frame number, exposure value, shutter speed, compression rate K, photographing date and time, flash ON/OFF data, scene information, image type, judged result of the image, etc) stored in the memory card 8, the compressed image and the thumbnail image are stored in the memory card 8.

When in the multiplex image taking mode the shutter button 9 is depressed to start taking images, after obtaining the N pieces of images into the image memory 209, the general control portion 211 creates a thumbnail image created from the image taken in the image memory 209 and the compressed image created by a JPEG method when the compression mode is selected by manipulating the compression rate setting slide switch 12. Operation for storing tag information (such as the frame number, exposure value, shutter speed, compression rate K, photographing date, flash ON/OFF data, scene information, judged result of the image, etc) stored in the memory card 8, the compressed image and the thumbnail image into the memory card 8 is repeated N times.

The function of each portion shown in the aforementioned embodiment may be performed by an independent circuit, a software or a combination thereof. Furthermore, the function may be performed by mutual action of a plurality of circuits.

By the way, multiplex image processing, i.e., processing for composing a plurality of images of the same photographic object sequentially taken into a single image, is performed for the various objects as will be explained below.

(1) Method for obtaining a super-resolution image

A plurality of images of the same photographic object are taken from slightly shifted image taking positions. Then, a single image with increased resolution is obtained from the plurality of images with different sampling phases.

(2) Depth control

In the depth control, a depth of field is changed without actually varying an aperture stop size. When a photographic object has a distance distribution, e.g., a foreground and a background, the foreground image and the background image are taken by focusing the foreground and the background, respectively. An image (all focused image) which is focused on both the foreground and the background or an image which emphasizes the unfocussed background is obtained from the aforementioned two images.

(3) Gradation control

In the gradation control, two images taken with different exposure levels are composed to extend the apparent dynamic range. The gradation characteristic (y curve) of the composite image is operated to make the optimal gradation reproducibility for the scene.

(4) Image stabilization

In cases where a proper shutter speed is S seconds and image blurring caused by a camera-movement is likely to occur on that condition, N pieces of images are taken (T×N=S) in a shutter speed of T seconds which does not cause image blurring caused by a camera-movement, then these images are composed into an image with no influence of a camera-movement.

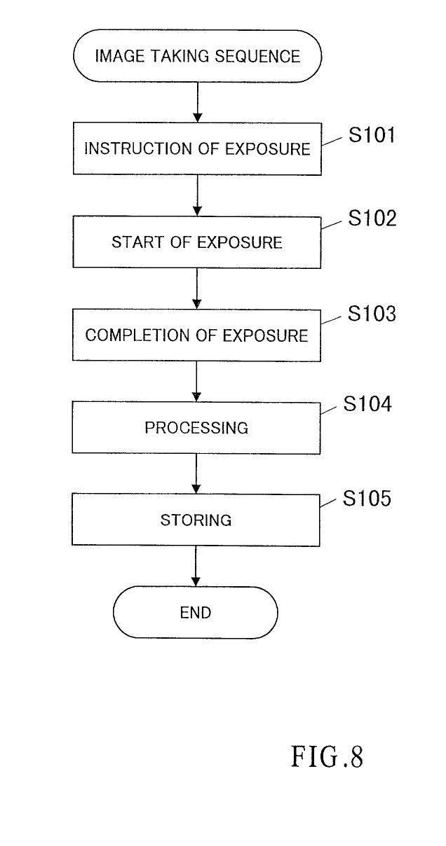

Next, in the digital camera 1, operation for performing a standard image taking (single image taking mode) will be first explained briefly with reference to the flow chart of FIG. 8. In the following explanation and the drawing, a step is abbreviated as “S”.

In S101, when the shutter button 9 is depressed by an user, exposure will start in S102. In S103, after the completion of the predetermined exposure, image processing, such as white balance compensation, gamma compensation, noise removal, color compensation and color emphasis, is performed in S104. In the meantime, after the predetermined exposure is completed and the images are stored in a buffer memory temporarily, the aforementioned image processing may be performed. In S105, image information is stored in the memory card 8 after the completion of the image processing.

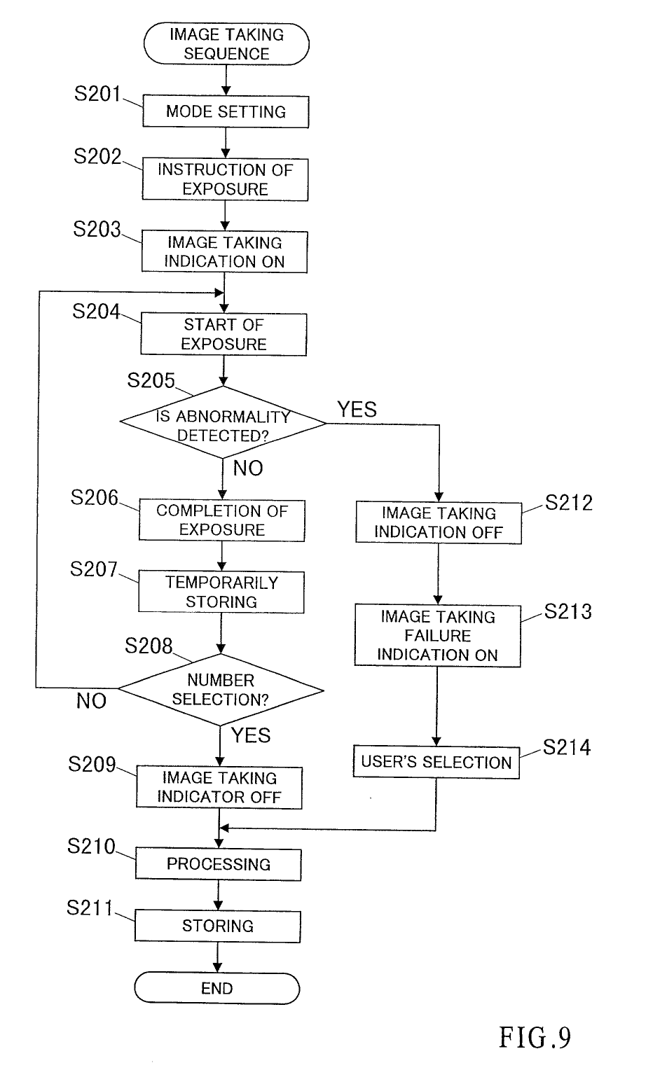

Next, in a multiplex image-taking mode, operation for performing abnormality detection during the image taking will be explained with reference to the flow chart of FIG. 9.

In S201, a mode setting is performed according to the mode setting operation by an user. Here, when set to the multiplex image taking mode, it becomes possible to set the number of images to be taken.

In S202, when the shutter button 9 is depressed by the operation of an user, the indicator 432 in the viewfinder (LCD display portion) will be turned on to indicate that images are being taken in the multiplex image taking mode in S203. Thereby, the user can recognize that the current mode is a multiplex image taking mode unlike a normal single image taking mode, a long time exposure mode or a motion picture taking mode.

In S204, when exposure starts, the general control portion 211 will judge whether or not the multiplex image taking was unsuccessful during the exposure in S205. If there is no abnormality (NO in S205), the exposure will be completed in S206 and the images taken are temporarily stored in the image memory 209 in S207.

Thereafter, in S208, it is judged whether or not the number of images taken has reached the predetermined number required by the multiplex image taking mode. If the number has not yet reached the predetermined number (NO in S208), the routine returns to S204 to repeat the predetermined operation. If the number has reached the predetermined number (YES in S208), in S209, the indicator 432 indicates that the multiplex image taking was completed, that is, the indicator is turned off. Subsequently, in S210, the white balance of the image stored in the image memory 209, etc. is processed, and in S211, all of the image data are stored in the memory card 8.

In S205, when abnormality (failure) during the multiplex image taking is detected by the general control portion 211 (YES in S205), the general control portion 211 suspends the processing of the normal multiplex image taking mode, turns off the indicator 432 indicating that the multiplex images are being taken in S212, and indicates by the indicator 431 that the multiplex image taking was unsuccessful in S213.

In S214, a dialog for making a user choose whether all of the images taken are to be left or whether some of the images taken are to be left is displayed on the LCD 10. When an user selects images, the routine proceeds to S210 to perform image processing, such as white balance compensation of the selected images. Subsequently, in S211, the selected images are stored in the memory card 8. Of course, it is also effective to automatically store all of the images taken or some of the images into the memory card 8, without the user's selection.

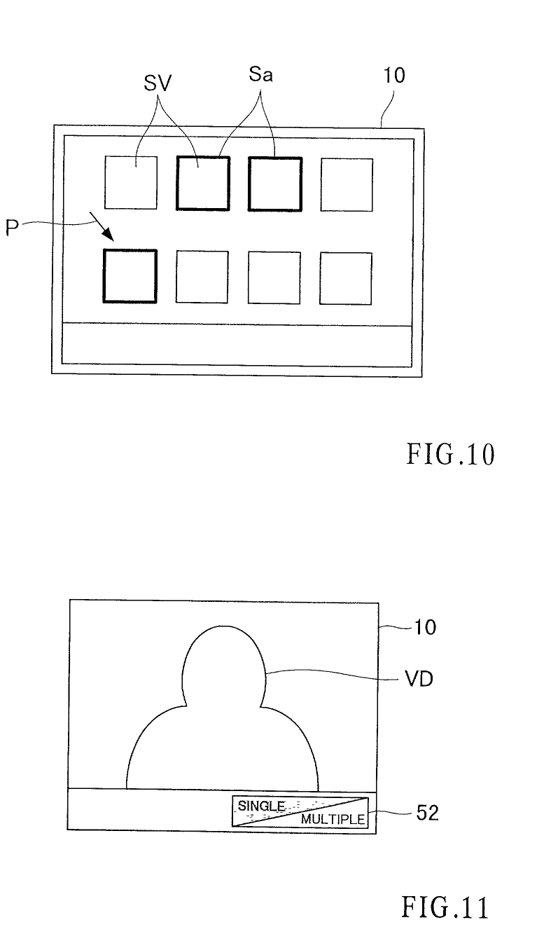

At the time of this image selection, as shown in FIG. 10, thumbnail images SV are displayed on the LCD 10. Since an user can move the arrow P on the screen to an arbitrary position by operating the UP key 6 and/or the DOWN key 7, it is possible for the user to switch a selection/non-selection of the image by depressing the shutter button 9 with the arrow P pointed on a desired image SV. In this embodiment, a selection of the thumbnail image SV causes a thicker border Sa thereof for an easy recognition of the selection. Alternatively, it is also possible to adopt any method in which a color of the whole image SV changes, etc.

Furthermore, when it comes to a power supply failure, a user can recognize the failure of the multiplex image taking. Thus, the user can replace a buttery with new one to send an instruction of the multiplex image taking again, or can dare to save the image as a single image.

By the way, in this embodiment, when a user starts to take images while looking at the viewfinder in a multiplex image taking mode, the indicator 432 in the viewfinder is automatically turned on. For this reason, even if an user misunderstands that the current mode is set to a single image taking mode, the user can recognize the current mode through the indicator, which enables to obtain multiplex images successfully.

In addition to the above, it is also possible to indicate that a single image taking mode is selected. For example, as shown in FIG. 11, the viewfinder may be provided with an indicator 52 selectively indicating a character of “single” or “multiplex,” wherein the “single” is displayed when an image is being taken in the single image taking mode, and the “multiplex” is displayed when images are being taken in the multiplex image taking mode. This enables an easy understanding of the meaning of the display.

Moreover, the indication showing the multiplex image taking mode may be any indication so long as it indicates that images are being taken in the mode. For example, if a mark which calls a user's attention not to move the digital camera 1 when images are being taken is indicated, the user can take images in a state that no camera-movement occurs taking into account of a multiplex image taking mode. This enables to obtain a plurality of images which do not cause a poor image.

Furthermore, if it is indicated by characters instead of a caution mark, even if a user is not familiar with the operation of the digital camera 1, the user can easily recognize that the current mode is a multiplex image taking mode, resulting in a user-friendly camera. Of course, a mark may be used to indicate that an image is being taken in a single image taking mode, and letters may be used to indicate that images are being taken in the multiplex image taking mode.

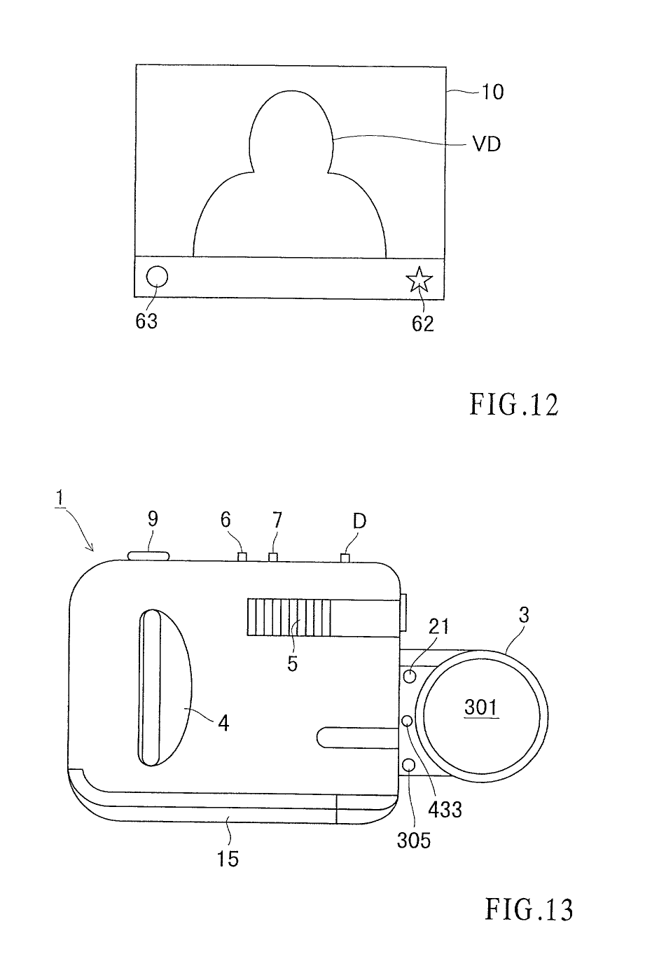

Furthermore, if it has a motion picture mode, it may be indicated in the viewfinder (LCD 10) such that a user can recognize that images are being taken in a multiplex image taking mode, and it may be indicated that movie images are being taken in the motion picture mode by an indication method different from the indication method for indicating the multiplex image taking without an indicator for a single image taking mode. Concretely, as shown in FIG. 12, it may be indicated by, for example, a star-shaped mark (or character) at the display portion 62 that multiple images are being taken, and by, for example, a round mark (or character) at the display portion 63 that movie images are being taken.

Moreover, at the outer surface of the digital camera 1, a display portion 433 consisting of a lamp, such as an LED, which indicates the multiplex image taking mode may be provided in the front surface of the image pick-up portion 3 like a tally lamp as shown in FIG. 13. This notifies that a photographic object person can also recognize that images are being taken in a multiplex image taking mode, which prevents the photographic object person from moving unwillingly.

Furthermore, in cases where the aforementioned display portion 433 is provided at the image pick-up portion 3, if the image pick-up portion 3 is capable of being separated from the camera main body 2, the photographic object person may not overlook that the image of the photographic object person is being taken in the multiplex image taking mode even in the state where the image pick-up portion 3 is separated from the camera main body 2. And if it is constituted such that the LED, etc. blinks, the function of calling attention to a photographic object person will be further enhanced.

Furthermore, it may also be displayed on an external monitor that multiplex images are being taken. In the event that the viewfinder or LCD 10 is not provided in the digital camera 1 or that the digital camera 1 is disposed at a place where it is difficult for an user to easily confirm the digital camera 1, it is possible to recognize that multiplex images are being taken through an external monitor's display.

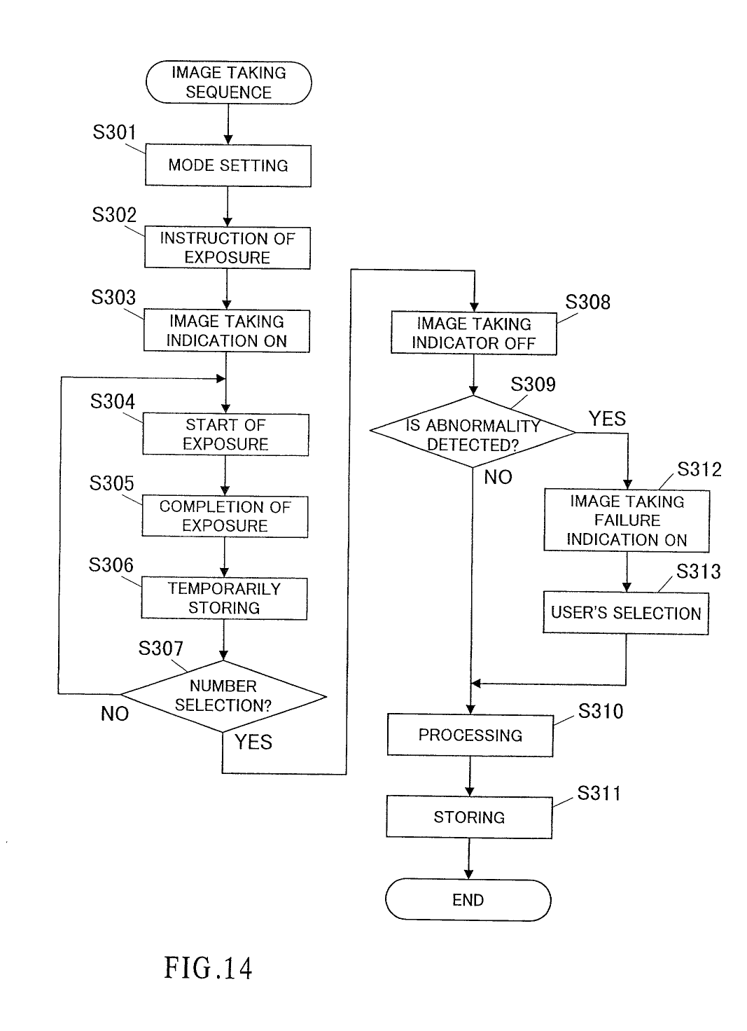

Next, in the multiplex image taking mode, the operation for detecting abnormality of the images taken will be explained with reference to the flow chart of FIG. 14.

First, in S301, a multiplex image taking mode is set. Then, in S302, when the shutter button 9 is depressed by the operation of an user, in S303, it will be displayed on the indicator 432 that multiplex images are being taken. Thereafter, exposure starts in S304. After the exposure is completed in S305, the image memory 209 stores the taken image in S306.

Subsequently, in S307, it is judged whether or not the number of images taken has reached the predetermined number required by the multiplex image taking mode. If the number has not reached the predetermined number (NO in S307), the routine returns to S304 to repeat the predetermined operation. If the number has reached the predetermined number (YES in S307), in S308, the indicator 432 in the viewfinder is turned off for indicating that the multiplex image taking was completed.

Thereafter, in S309, the general control portion 211 judges whether or not the multiplex image taking was unsuccessful from the contents of image data, the number of image data, or the like. If there is no abnormality (NO in S309), in S310, image processing, such as white balance compensation, will be subjected to all the images temporarily stored in the image memory 209. Then, in S311, the image information on all of the images will be stored in the memory card 8.

In the event that the number of images required by a user has not been taken, or in the event that abnormality occurs, e.g., blur of an image caused by camera-movement is conspicuous although the number of images is enough, or blackish portions or whitish portions in which shadow gradation or highlight gradation is lost have occurred, the general control portion 211 detects the abnormality (YES in S309). The general control portion 211 suspends the processing in the normal multiplex image taking mode. Then, in S312, it is indicated by the indicator 431 in the viewfinder that the multiplex image taking was unsuccessful.

Then, in S313, a dialog for making a user choose whether all of the images taken are to be left or whether some of the images taken are to be left is displayed on the LCD 10. When an user selects images, the routine proceeds to S310 to perform image processing, such as white balance compensation of the selected images. Subsequently, in S311, the selected images are stored in the memory card 8. Of course, it is also effective to automatically store all of the images taken or some of the images into the memory card 8, without the user's selection.

In cases where the multiplex images include an inappropriate image with the aforesaid blurs, blackish portions or whitish portions although the number of images for the multiplex image processing is enough, the appearance of the final composite image becomes poor because of the influence of the poor image. Thus, the multiplex images are not suitably subjected to the multiplex image processing. That is, it becomes possible to delete the poor image by the user because of the temporary suspension of the multiplex image taking.

By the way, even if the images taken in the multiplex image taking mode are unsuitable for multiplex image processing, in the event that a user missed a photo opportunity, it is sometimes difficult to take the image of the same scene again. Even in such a situation, the image can be stored in the memory card 8 as a single image by the operation of the user, not treating the images to be subjected to multiplex image processing.

In this case, it is possible to automatically select some of the images to be stored into the digital camera 1 among the plurality of images taken for the multiplex image processing.

In the meantime, in the event that an user selects some desired images among the images taken in the multiplex image taking mode and stores them in the memory card 8, the capacity of the memory card 8 can be saved, resulting in a larger number of images stored therein.

As mentioned above, although an embodiment according to the present invention was explained, the present invention is not limited to the above embodiment. In the aforementioned embodiment, when abnormality disturbing the multiplex image processing is detected, the processing in the multiplex image taking mode is suspended, and it is indicated on the display or indicator that there is abnormality. However, it may be performed one of them, a suspension of the image taking mode or a display of abnormality. Alternatively, when abnormality is detected, it may be possible to instruct a re-trial of the multiplex image taking.

In the aforementioned embodiment, although a detection of abnormality during the image taking and a detection of abnormality based on the image data after having taken images are separately performed, both the detections may be performed in the same multiplex image taking mode.

In the aforementioned embodiment, the indicator 431 for indicating abnormality and the indicators 432, 52 and 62 for indicating the multiplex image taking and the indicator 63 are provided on the LCD 10 as a viewfinder. However, in cases where the digital camera 1 is provided with an optical or electronic viewfinder, the aforementioned indicator 431, 432 and the like, may be provided in such a viewfinder. Moreover, the indicator may consist of, for example, light emitting diodes instead of liquid crystal display. In the meantime, the indicator may be provided at a portion other than the viewfinder portion, for example, a portion on the external surface of the digital camera 1. In this case, the indicator can be provided even if the camera has no viewfinder or does not perform electric processing within a viewfinder. However, it is preferable to provide the indicator in the viewfinder through which a user always looks the image of the photographic object during the image taking because the indicator can be enhanced in visibility.

In the aforementioned embodiment, although an external apparatus performs the multiplex image processing and a digital camera performs from image taking to record of images, a digital camera may have a multiplex image processing function.

The terms and descriptions in this specification are used only for explanatory purposes and the present invention is not limited to these terms and descriptions. It should be appreciated that there are many modifications and substitutions without departing from the spirit and the scope of the present invention which is defined by the appended claims.

What is claimed is:

1. An image taking apparatus having a multiplex image taking mode for taking a plurality of images to be subjected to multiplex image processing by which a plurality of images are composed into a single image, the image taking apparatus, comprising:
a detector which detects abnormality disturbing said multiplex image processing when said plurality of images are being taken in said multiplex image taking mode; and
a controller which suspends processing in said multiplex image taking mode when said abnormality is detected by said detector.

2. An image taking apparatus having a multiplex image taking mode for taking a plurality of images to be subjected to multiplex image processing by which a plurality of images are composed into a single image, the image taking apparatus, comprising:
a detector which detects whether or not abnormality disturbing said multiplex image processing resides in said plurality of images taken in said multiplex image taking mode; and
a controller which suspends processing in said multiplex image taking mode when said abnormality is detected by said detector.

3. An image taking apparatus having a multiplex image taking mode for taking a plurality of images to be subjected to multiplex image processing by which a plurality of images are composed into a single image, the image taking apparatus, comprising:
a detector which detects abnormality disturbing said multiplex image processing when said plurality of images are being taken in said multiplex image taking mode; and
a display which indicates that a multiplex image taking is unsuccessful when said abnormality is detected by said detector.

4. An image taking apparatus having a multiplex image taking mode for taking a plurality of images to be subjected to multiplex image processing by which a plurality of images are composed into a single image, the image taking apparatus, comprising:
a detector which detects whether or not abnormality disturbing said multiplex image processing resides in said plurality of images taken in said multiplex image taking mode; and
a display which indicates that a multiplex image taking is unsuccessful when said abnormality is detected by said detector.

5. An image taking method, comprising:
detecting abnormality disturbing multiplex image processing when a plurality of images are being taken, wherein said plurality of images are subjected to said multiplex image processing to be composed into a single image; and
suspending processing in said multiplex image taking mode when said abnormality is detected.

6. An image taking method, comprising:
detecting abnormality residing in a plurality of images taken by a multiplex image taking, wherein said abnormality disturbs multiplex image processing of said plurality of images by which said plurality of images are composed into a single image; and
suspending processing in said multiplex image taking mode when said abnormality is detected.

7. An image taking apparatus having a multiplex image taking mode for taking a plurality of images to be subjected to multiplex image processing by which a plurality of images are composed into a single image, the image taking apparatus, comprising:
a display which indicates that images are being taken in said multiplex image taking mode.

8. A camera, comprising:
a selector which selects a first mode for taking a single image or a second mode for taking a plurality of images to be composed into a single image; and
a display which indicates said first mode or said second mode.

9. The camera as recited in claim 8, wherein said display indicates said second mode so that a user can recognize said second mode.

10. The camera as recited in claim 8, further comprising a monitor for displaying an image to be taken, wherein said display is disposed at a location where a user can recognize said display together with said monitor.

11. The camera as recited in claim 8, further comprising a detector for detecting whether or not there is abnormality disturbing said composing when images are being taken in said second mode.

12. The camera as recited in claim 11, further comprising a controller which suspends processing in said second mode when said abnormality is detected by said detector.

13. A camera, comprising:
a selector which selects a specific mode for taking a plurality of images to be composed into a single image among a plurality of image taking modes;
a detector for detecting whether or not there is abnormality disturbing said composing when said plurality of images are being taken in said specific mode; and
a controller which suspends processing in said specific mode when said abnormality is detected by said detector.

14. A camera, comprising:
a selector which selects a specific mode for taking a plurality of images to be composed into a single image among a plurality of image taking modes;
a detector which detects whether or not abnormality disturbing said composing resides in said plurality of images taken in said specific mode; and
a controller which suspends processing in said specific mode when said abnormality is detected by said detector.

15. A camera, comprising:
a selector which selects a specific mode for taking a plurality of image to be composed into a single image among a plurality of image taking modes;
a detector for detecting whether or not there is abnormality disturbing said composing when said plurality of images are being taken in said specific mode; and
a display which indicates that said image taking in said specific mode is unsuccessful when said abnormality is detected by said detector.

16. A camera, comprising:
a selector which selects a specific mode for taking a plurality of images to be composed into a single image among a plurality of image taking modes;
a detector which detects whether or not abnormality disturbing said composing resides in said plurality of images taken in said specific mode; and
a display which indicates that said image taking in said specific mode is unsuccessful when said abnormality is detected by said detector.
